(19) United States
(12) Patent Application Publication
(10) Pub. No.: US 2016/0115023 A1
(43) Pub. Date: Apr. 28, 2016

(54) RECOVERY OF HYDROGEN FROM FRACTIONATION ZONE OFFGAS

(71) Applicant: UOP LLC, Des Plaines, IL (US)

(72) Inventor: Richard K. Hoehn, Mt. Prospect, IL (US)

(21) Appl. No.: 14/521,251

(22) Filed: Oct. 22, 2014

(51) Int. Cl. C01B 3/52; C10G 11/05; B01J 19/24; C10G 45/00; B01J 8/18; C10G 47/18; C10G 45/12

(52) U.S. Cl. CPC C01B 3/52; C10G 47/18; C10G 11/05; C10G 45/12; C10G 45/00; B01J 8/18; B01J 19/24; B01J 2208/00796; B01J 2219/24; C01B 2203/0485; C01B 2203/0415

(57) ABSTRACT

Methods and apparatus for increasing the recovery of hydrogen from fractionation section offgas are described. The methods include reducing the pressure of a liquid effluent from a high-pressure reaction zone, and introducing the effluent into a flash drum forming a low pressure liquid effluent. The low pressure effluent is introduced into a low-pressure stripper column, and separated into an overhead vapor stream and at least one additional stream. The stripper column overhead vapor stream is compressed in a one cylinder of a compressor, which has at least one additional cylinder, to an intermediate pressure. The compressed overhead stream is introduced to an intermediate pressure knockout drum forming a gas stream and a liquid stream. The gas stream is introduced into a pressure swing adsorption zone to produce a hydrogen rich gas stream at an intermediate pressure.

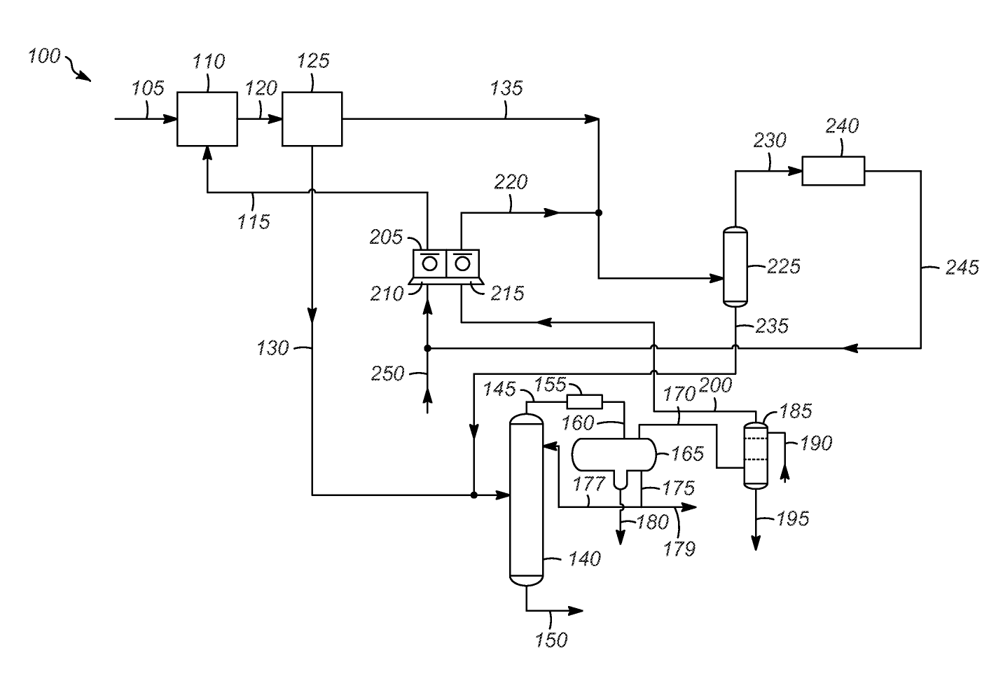

### BACKGROUND OF THE INVENTION

In a typical hydroprocessing unit, the effluent from the reactor, which contains hydrogen, is routed to the fractionation zone. The feed to the fractionation zone contains some hydrogen, which ends up in the offgas at low pressure. The low pressure hydrogen is not normally recoverable using current technologies. The amount of hydrogen contained in the feed to the fractionation section is typically about 5 to about 10 volume % of the total makeup gas requirement for the reactor. For locations where hydrogen is expensive, this hydrogen loss represents a sizable cost.

Therefore, there is a need for processes for recovery of hydrogen from the liquid effluent from a high pressure reaction zone.

### SUMMARY OF THE INVENTION

One aspect of the present invention is a method of increasing the recovery of hydrogen from fractionation section off-gas. In one embodiment, the method includes reducing the pressure of a liquid effluent from a high-pressure reaction zone, and introducing the reduced pressure effluent into a flash drum to form a low pressure liquid effluent and a flash gas stream. The low pressure liquid effluent is introduced into a low-pressure stripper column, and separated into an overhead vapor stream and at least one additional stream in the stripper column. The stripper column overhead vapor stream is compressed in a first cylinder of a compressor to an intermediate pressure. The compressor has at least one additional cylinder. The compressed overhead vapor stream is introduced to an intermediate pressure knockout drum to form a gas stream and a liquid stream. The gas stream from the intermediate pressure knockout drum is introduced into a pressure swing adsorption zone to produce a hydrogen rich gas stream at an intermediate pressure.

Another aspect of the invention is an apparatus for increasing the recovery of hydrogen from a fractionation section. The apparatus includes a high-pressure reaction zone having an inlet and at least one outlet; a flash drum having an inlet, a liquid outlet, and a vapor outlet, the inlet of the flash drum being in fluid communication with the outlet of the high-pressure reaction zone; a low-pressure stripper column having an inlet, and an overhead outlet, the inlet of the low-pressure stripper column being in fluid communication with the liquid outlet of the flash drum; a compressor having a plurality of cylinders including at least one high pressure cylinder and at last one intermediate pressure cylinder, the at least one high pressure cylinder having an inlet and an outlet, the at least one intermediate pressure cylinder having an inlet and an outlet, the outlet of the at least one high pressure cylinder being in fluid communication with the inlet of the high pressure reaction zone, the inlet of the at least one intermediate pressure cylinder being in fluid communication with the overhead outlet of the low-pressure stripper column; an intermediate pressure knockout drum having an inlet, and a gas outlet, the inlet of the intermediate pressure knockout drum being in fluid communication with the outlet of the at least one intermediate pressure cylinder; a pressure swing adsorption unit having an inlet and an outlet, the inlet of the pressure swing adsorption unit being in fluid communication with the gas outlet of the intermediate pressure knockout drum, the outlet of the pressure swing adsorption unit being in fluid communication with the inlet of the at least one high pressure cylinder.

### BRIEF DESCRIPTION OF THE DRAWING

The FIGURE illustrates one embodiment of a process utilizing the process of the present invention.

### DETAILED DESCRIPTION OF THE INVENTION

The present invention solves the problem of recovering low pressure hydrogen from the offgas from the fractionation section by utilizing an auxiliary cylinder on the makeup gas compressor to compress the fractionation zone offgas to a pressure that allows it to be routed to the pressure swing adsorption (PSA) unit. In this way, it is not necessary to install a separate set of compressors to increase the pressure so that the offgas can be sent to the PSA unit for hydrogen recovery.

The fractionation zone offgas can be scrubbed to remove hydrogen sulfide before being sent to the auxiliary cylinder on the makeup gas compressor to be compressed. The compressed offgas can be combined with the scrubbed flash gas from the reaction zone. This reduces the makeup gas requirement by approximately 5% to 10%. Scrubbing the fractionation zone offgas before compression minimizes valve problems at the compressor which would be expected when compressing wet sour gas.

As shown in the FIGURE, the process 100 involves the introduction of hydrocarbon feed 105 into a high pressure reaction zone 110 along with a high pressure hydrogen stream 115. Typical feeds for the process include, but are not limited to atmospheric or vacuum gas oils, thermally cracked gas oils, and deasphalted oils.

The high pressure reaction zone 110 can be a hydroprocessing zone.

Hydroprocessing can include processes which convert hydrocarbons in the presence of hydroprocessing catalyst and hydrogen to more valuable products. Hydrocracking is a hydroprocessing process in which hydrocarbons crack in the presence of hydrogen and hydrocracking catalyst to lower molecular weight hydrocarbons. Depending on the desired output, the hydrocracking zone may contain one or more beds of the same or different catalyst. Hydrocracking is a process used to crack hydrocarbon feeds such as vacuum gas oil (VGO) to diesel including kerosene and gasoline motor fuels.

Mild hydrocracking is generally used upstream of a fluid catalytic cracking (FCC) or other process unit to improve the quality of an unconverted oil that can be fed to the downstream unit, while converting part of the feed to lighter products such as diesel. As world demand for diesel motor fuel is growing relative to gasoline motor fuel, mild hydrocracking is being considered for biasing the product slate in favor of diesel at the expense of gasoline. Mild hydrocracking may be operated with less severity than partial or full conversion hydrocracking to balance production of diesel with the FCC unit, which primarily is used to make naphtha. Partial or full conversion hydrocracking is used to produce diesel with less yield of the unconverted oil which can be fed to a downstream unit.

Hydrotreating is a hydroprocessing process used to remove heteroatoms such as sulfur and nitrogen from hydrocarbon streams to meet fuel specifications and to saturate olefinic compounds. Hydrotreating can be performed at high or low pressures, but is typically operated at lower pressure than hydrocracking. In such cases, there is need of coordinating process units when they are operated at different pressures.

The hydroprocessing zone 110 may comprise one or more vessels, multiple beds of catalyst in each vessel, and various combinations of hydrotreating catalyst and hydrocracking catalyst in one or more vessels. In some aspects, the hydrocracking reaction provides a partial total conversion of about 20 vol-% to about 99.5 vol-% of the hydrocarbon feed to products boiling below the diesel cut point. The first vessel or bed may include hydrotreating catalyst for the purpose of demetallizing, desulfurizing or denitrogenating the hydrocracking feed.

The hydroprocessing zone 110 may be operated at mild hydrocracking conditions. Mild hydrocracking conditions will provide about 20 to about 60 vol-%, preferably about 20 to about 50 vol-%, total conversion of the hydrocarbon feed to product boiling below the diesel cut point. In mild hydrocracking, converted products are biased in favor of diesel. In a mild hydrocracking operation, the hydrotreating catalyst has just as much or a greater conversion role than hydrocracking catalyst. Conversion across the hydrotreating catalyst may be a significant portion of the overall conversion. If the hydroprocessing zone 110 is intended for mild hydrocracking, it is contemplated that the hydroprocessing zone 110 may be loaded with all hydrotreating catalyst, all hydrocracking catalyst, or some beds of hydrotreating catalyst and some beds of hydrocracking catalyst. In the last case, the beds of hydrocracking catalyst may typically follow beds of hydrotreating catalyst.

The hydroprocessing zone 110 can have one or more beds in one reactor vessel. If mild hydrocracking is desired, it is contemplated that the first catalyst bed comprises hydrotreating catalyst and the second catalyst bed comprises hydrocracking catalyst.

At mild hydrocracking conditions, the feed is selectively converted to heavy products such as diesel and kerosene with a low yield of lighter hydrocarbons such as naphtha and gas. Pressure is also moderate to limit the hydrogenation of the bottoms product to an optimal level for downstream processing.

In one aspect, for example, when a balance of middle distillate and gasoline is preferred in the converted product, mild hydrocracking may be performed in the hydrocracking zone with hydrocracking catalysts that utilize amorphous silica-alumina bases or low-level zeolite bases combined with one or more Group VIII or Group VIB metal hydrogenating components. In another aspect, when middle distillate is significantly preferred in the converted product over gasoline production, partial or full hydrocracking may be performed in the first hydrocracking zone with a catalyst which comprises, in general, any crystalline zeolite cracking base upon which is deposited a Group VIII metal hydrogenating component. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms (10⁻¹⁰ meters). It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8-12 Angstroms (10⁻¹⁰ meters), wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared first in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,130,006.

Mixed polyvalent metal-hydrogen zeolites may be prepared by ion-exchanging first with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 percent, and preferably at least about 20 percent, metal-cation-deficient, based on the initial ion-exchange capacity. In another aspect, a desirable and stable class of zeolites is one wherein at least about 20 percent of the ion exchange capacity is satisfied by hydrogen ions.

The active metals employed in the preferred hydrocracking catalysts of the present invention as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 percent and about 30 percent by weight may be used. In the case of the noble metals, it is normally preferred to use about 0.05 to about 2 wt-%.

The method for incorporating the hydrogenating metal is to contact the base material with an aqueous solution of a suitable compound of the desired metal wherein the metal is present in a cationic form. Following addition of the selected hydrogenating metal or metals, the resulting catalyst powder is then filtered, dried, pelleted with added lubricants, binders or the like if desired, and calcined in air at temperatures of, e.g., about 371° C. to about 648° C. (about 700° F. to about 1200° F.) in order to activate the catalyst and decompose ammonium ions. Alternatively, the base component may first be pelleted, followed by the addition of the hydrogenating component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt-%. These diluents may be employed as such or they may contain a minor proportion of an added hydrogenating metal such as a Group VIB and/or Group VIII metal. Additional metal promoted hydrocracking catalysts may also be utilized in the process of the present invention which comprises, for example, aluminophosphate molecular sieves, crystalline chromosilicates and other crystalline silicates. Crystalline chromosilicates are more fully described in U.S. Pat. No. 4,363,718.

By one approach, the hydrocracking conditions may include a temperature from about 290° C. (550° F.) to about 450° C. (850° F.), preferably 343° C. (650° F.) to about 435° C. (815° F.), a pressure from about 3.5 MPa (500 psig) to about 20.7 MPa (3000 psig), a liquid hourly space velocity (LHSV) from about 0.4 to less than about 2.5 hr⁻¹ and a hydrogen rate of about 421 to about 2,527 Nm³/m³ oil (2,500-15,000 scf/bbl). If mild hydrocracking is desired, conditions may include a temperature from about 315° C. (600° F.) to about 441° C. (825° F.) or about 370° C. (700° F.) to about 440° C. (820° F.), a pressure from about 5.5 MPa (g) (800 psig) to about 15.2 MPa (g) (2200 psig), or about 5.5 MPa (g) (800 psig) to about 13.8 MPa (gauge) (2000 psig) or more typically about 6.9 to about 11.0 MPa (gauge) (1000 to 1600 psig), a liquid hourly space velocity (LHSV) from about 0.5 to about 2 hr⁻¹ and preferably about 0.7 to about 1.5 hr⁻¹ and a hydrogen rate of about 421 to about 1,685 Nm³/m³ oil (2,500-10,000 scf/bbl).

The high pressure reaction zone typically operates at a pressure in the range of about 5.5 MPa (g) to about 20.7 MPa (g) (800 psig to 3000 psig).

The pressure of the reactor effluent 120 is reduced (e.g., using a control valve designed to impose the required pressure drop), and it is sent to a flash drum 125 where a low pressure liquid effluent 130 and a flash gas stream 135 are formed.

The low pressure liquid effluent 130 is sent to a low pressure stripper column 140 where it is separated into an overhead vapor stream 145 and at least one additional stream 150.

The low pressure stripper typically operates at an overhead pressure in the range of about 0.35 MPa (g) (50 psig) to about 1.4 MPa (g) (200 psig) and with a bottoms temperature between about 200° C. (400° F.) and about 288° C. (550° F.).

The overhead vapor stream 145 comprises hydrogen, hydrogen sulfide, and light hydrocarbons. The at least one additional stream can be one or more vapor and/or liquid streams.

The overhead vapor stream 145 from the stripper column 140 is sent to condenser 155 where it is partially condensed. The outlet 160 from the condenser is routed to overhead receiver 165, where it is separated into a hydrocarbon liquid stream 175, which exits the bottom of the receiver, an aqueous stream 180, which exits the bottom of the receiver 165, and a vapor stream 170, which exits the upper portion of the receiver. A portion 177 of the hydrocarbon stream 175 is refluxed to the low pressure stripper column 140. The remaining portion 179 of the hydrocarbon stream 175 is the column net overhead liquid, which can be sent for light hydrocarbon recovery.

The vapor stream 170 is sent to a purification zone, such as an amine scrubber 185. A lean amine stream 190 enters the amine scrubber 185 where it reacts with the hydrogen sulfide in the vapor stream 170 to remove the hydrogen sulfide from the vapor stream 170. A rich amine stream 195 containing the hydrogen sulfide and a purified vapor stream 200 which has a lower level of hydrogen sulfide than incoming vapor stream 170 are formed.

The purified vapor stream 200, which is at low pressure, is sent to compressor 205. Compressor 205 has at least one high pressure cylinder 210 and at least one intermediate pressure cylinder 215. The purified vapor stream 200 is compressed from low pressure to an intermediate pressure in the intermediate pressure cylinder 215 of the compressor 205.

The intermediate pressure compressed vapor stream 220 is sent to the knockout drum 225. In some embodiments, the intermediate pressure compressed vapor stream 220 is combined with the flash gas stream 135 from the flash drum 125 before being introduced into the knockout drum 225.

The intermediate pressure compressed vapor stream 220 is separated into a gas stream 230 and a liquid stream 235 in the knockout drum 225.

Liquid stream 235 can be combined with the low pressure liquid effluent 130 from the flash drum 125, and the combined stream can be sent to the stripper column 140.

The gas stream 230 from the knockout drum 225 is introduced into a pressure swing adsorption (PSA)) unit 240 for purification. In operation, the gas stream 230 is introduced into a packed bed, and the adsorbent material contained therein removes impurities, such as hydrocarbons, carbon monoxide, carbon dioxide, nitrogen, oxygen, hydrogen sulfide, and water, known as the sorbate, from the stream as it flows through the packed bed. After a given time period, the adsorbent material becomes saturated with the sorbate, and the adsorption process must be halted in order to regenerate the adsorbent and remove the sorbate. PSA processes utilize a de-pressurized desorption gas that is introduced to the packed bed to remove the sorbate from the packed bed. After a desorption cycle is complete, a new adsorption cycle can begin.

Packed beds of adsorbent materials are typically used in PSA processes. The adsorbent materials are generally in the form of spherical beads, or extruded pellets. Alternatively, it may be shaped into honeycomb monolithic structures. The adsorbent may comprise powdered solid, crystalline or amorphous compounds capable of adsorbing and desorbing the adsorbable compound. Examples of such adsorbents include silica gels, activated aluminas, activated carbon, molecular sieves, and mixtures thereof Molecular sieves include zeolite molecular sieves. The adsorbent materials are typically zeolites. In a processing scheme such as the one depicted in the FIGURE, the PSA unit 240 is typically operated at feed pressures ranging from about 2.0 MPa (g) to about 3.1 MPa (g).

Generally, such PSA units operate on a cyclic basis, with individual adsorber vessels cycled between adsorption and desorption steps. Multiple adsorbers are commonly used in order to provide constant product and tail gas flows. By operating multiple adsorbers in series in the adsorption mode the purity of the hydrogen stream is increased. Typical purities for PSA hydrogen product streams range from 99 to 99.999% by volume with a series of adsorbers.

Adsorbents are selected based on the type and quantity of impurities present in the feed stream and also the required degree of removal of such impurities. Such PSA units and their operation are more fully described, for example, in U.S. Pat. Nos. 4,964,888 and 6,210,466, for example.

In some embodiments, acid gases, such as carbon dioxide and hydrogen sulfide, can be removed from the gas stream before it enters the PSA unit 240 using known technologies, such as absorbent processes, membrane processes, and temperature swing adsorption processes.

The hydrogen rich stream 245 from the PSA unit 240 is sent to the high pressure cylinder 210 of the compressor 205. In some embodiments, it can be combined with makeup hydrogen 250. The high pressure compressed hydrogen stream comprises high pressure hydrogen stream 115 which is sent to the high pressure reaction zone 110.

The terms “low pressure,” “intermediate pressure,” and “high pressure” are relative terms which express the relationship among the pressures of the various pieces of equipment and streams. Low pressure is a pressure less than the intermediate and high pressures. High pressure is a pressure greater than the intermediate and low pressures. Intermediate pressure is a pressure between the low pressure and the high pressure. For example, high pressure can be in the range of about 5.5 MPa (g) to about 18.0 MPa (g), low pressure can be in the range of about 0.7 MPa (g) to about 1.4 MPa (g), and intermediate pressure can be in the range of about 2.0 MPa (g) to about 3.1 (g). Those of skill in the art will understand that other pressure ranges are possible as long as the relationship among the pressures is preserved.

By “about” we mean within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of increasing the recovery of hydrogen from fractionation section off-gas comprising:
reducing a pressure of a liquid effluent from a high-pressure reaction zone;
introducing the reduced pressure effluent into a flash drum to form a low pressure liquid effluent and a flash gas stream;
introducing the low pressure liquid effluent into a low-pressure stripper column;
separating the low pressure liquid effluent into an overhead vapor stream and at least one additional stream in the stripper column;
compressing the stripper column overhead vapor stream in a first cylinder of a compressor to an intermediate pressure, the compressor having at least one additional cylinder;
introducing the compressed overhead vapor stream to an intermediate pressure knockout drum to form a gas stream and a liquid stream;
introducing the gas stream from the intermediate pressure knockout drum into a pressure swing adsorption zone to produce a hydrogen rich gas stream at an intermediate pressure.

2. The method of claim 1 further comprising:
compressing the hydrogen rich gas stream at the intermediate pressure to a high pressure in the at least one additional cylinder of the compressor; and
introducing the compressed hydrogen rich gas stream to the high-pressure reaction zone.

3. The method of claim 1 further comprising:
separating the stripper column overhead vapor stream into a liquid stream and a vapor stream in a separator before compressing the stripper column overhead vapor stream.

4. The method of claim 1 further comprising:
removing hydrogen sulfide from the stripper column overhead vapor stream before compressing the stripper column overhead vapor stream.

5. The method of claim 4 wherein the hydrogen sulfide is removed in an amine scrubber.

6. The method of claim 1 further comprising combining the compressed overhead vapor stream with the flash gas stream from the flash drum to form a combined vapor stream, and wherein introducing the compressed overhead vapor stream to the intermediate pressure knockout drum comprises introducing the combined vapor stream to the intermediate pressure knockout drum.

7. The method of claim 1 further comprising:
combining the liquid stream from the intermediate pressure knockout drum with the low pressure liquid effluent from the flash drum before introducing the low pressure liquid effluent into the low-pressure stripper column.

8. The method of claim 1 further comprising:
compressing make-up hydrogen gas in the at least one additional cylinder of the compressor;
introducing the compressed make-up hydrogen gas into the high-pressure reaction zone.

9. The method of claim 1 wherein the high-pressure reaction zone is at a pressure in a range of about 5.5 MPa (g) to about 18.0 MPa (g), the low-pressure stripper column is at a pressure in a range of about 0.7 MPa to about 1.4 MPa (g), and the intermediate pressure flash drum is at a pressure in a range of about 2.0 MPa (g) to about 3.1 MPa (g).

10. A method of increasing the recovery of hydrogen from fractionation section off-gas comprising:
reducing a pressure of a liquid effluent from a high-pressure reaction zone, the high-pressure reaction zone being at a high pressure in a range of about 5.5 MPa (g) to about 18.0 MPa (g);
introducing the reduced pressure effluent into a flash drum to form a low pressure liquid effluent and a flash gas stream;
introducing the low pressure liquid effluent into a low-pressure stripper column, the low-pressure stripper column being at a low pressure in a range of about 0.7 MPa (g) to about 1.4 MPa (g);
separating the low pressure liquid effluent into an overhead vapor stream and at least one additional stream in the stripper column;
separating the stripper column overhead vapor stream into a liquid stream and a vapor stream in a separator;
compressing the vapor stream in a first cylinder of a compressor to an intermediate pressure, the compressor having at least one additional cylinder;
introducing the compressed overhead vapor stream to an intermediate pressure knockout drum to form a gas stream and a liquid stream, the intermediate pressure knockout drum being at an intermediate pressure in a range of about 2.0 MPa (g) to about 3.1 MPa (g);
introducing the gas stream from the intermediate pressure knockout drum into a pressure swing adsorption zone to produce a hydrogen rich gas stream at the intermediate pressure.

11. The method of claim 10 further comprising:
compressing the hydrogen rich gas stream at the intermediate pressure to the high pressure in the at least one additional cylinder of the compressor; and
introducing the compressed hydrogen rich gas stream to the high-pressure reaction zone.

12. The method of claim 10 further comprising:
removing hydrogen sulfide from the stripper column overhead vapor stream before compressing the stripper column overhead vapor stream.

13. The method of claim 12 wherein the hydrogen sulfide is removed in an amine scrubber.

14. The method of claim 10 further comprising combining the compressed overhead vapor stream with the flash gas stream from the flash drum to form a combined vapor stream, and wherein introducing the compressed overhead vapor stream to the intermediate pressure knockout drum comprises introducing the combined vapor stream to the intermediate pressure knockout drum.

15. The method of claim 10 further comprising:
combining the liquid stream from the intermediate pressure knockout drum with the low pressure liquid effluent from the flash drum before introducing the low pressure liquid effluent into the low-pressure stripper column.

16. The method of claim 10 further comprising:
compressing make-up hydrogen gas in the at least one additional cylinder of the compressor;
introducing the compressed make-up hydrogen gas into the high-pressure reaction zone.

17. An apparatus for increasing the recovery of hydrogen from a fractionation section comprising:
a high-pressure reaction zone having an inlet and at least one outlet;
a flash drum having an inlet, a liquid outlet, and a vapor outlet, the inlet of the flash drum being in fluid communication with the outlet of the high-pressure reaction zone;
a low-pressure stripper column having an inlet, and an overhead outlet, the inlet of the low-pressure stripper column being in fluid communication with the liquid outlet of the flash drum;
a compressor having a plurality of cylinders including at least one high pressure cylinder and at last one intermediate pressure cylinder, the at least one high pressure cylinder having an inlet and an outlet, the at least one intermediate pressure cylinder having an inlet and an outlet, the outlet of the at least one high pressure cylinder being in fluid communication with the inlet of the high pressure reaction zone, the inlet of the at least one intermediate pressure cylinder being in fluid communication with the overhead outlet of the low-pressure stripper column;
an intermediate pressure knockout drum having an inlet, and a gas outlet, the inlet of the intermediate pressure knockout drum being in fluid communication with the outlet of the at least one intermediate pressure cylinder;
a pressure swing adsorption unit having an inlet and an outlet, the inlet of the pressure swing adsorption unit being in fluid communication with the gas outlet of the intermediate pressure knockout drum, the outlet of the pressure swing adsorption unit being in fluid communication with the inlet of the at least one high pressure cylinder.

18. The apparatus of claim 17 further comprising:
a separator having an inlet and at least one outlet, the inlet of the separator being in fluid communication with the overhead outlet of the low-pressure stripper column; and
a scrubber having an inlet and an outlet, the inlet of the scrubber being in fluid communication with the outlet of the separator, and the outlet of the scrubber being in fluid communication with the inlet of the at least one intermediate pressure cylinder.

19. The apparatus of claim 17 further comprising a pressure reducing control between the outlet of the high-pressure reaction zone and the inlet of the flash drum.

20. The apparatus of claim 17 wherein the vapor outlet of the flash drum is in fluid communication with the inlet of the intermediate pressure knockout drum.
